(19) United States
(12) Patent Application Publication
(10) Pub. No.: US 2018/0356277 A1
(43) Pub. Date: Dec. 13, 2018

(54) METHOD FOR DOSING ONE OR MORE TREATMENT SUBSTANCES IN A SYSTEM FOR WASHING AND RECYCLING PLASTICS

(71) Applicant: PREVIERO N. S.R.L., Lissone (IT)

(72) Inventor: Flavio PREVIERO, Lipomo (IT)

(21) Appl. No.: 15/778,710

(22) PCT Filed: Nov. 25, 2016
(86) PCT No.: PCT/IB2016/001671

§ 371 Date: May 24, 2018

(30) Foreign Application Priority Data
Nov. 25, 2015 (IT) UB2015A005870

(51) Int. Cl. G01G 13/00; G01G 17/06; B08B 3/04; B08B 13/00; B29B 17/02; B29B 17/04

(52) U.S. Cl. CPC G01G 13/006; G01G 17/06; B08B 3/04; B29K 2067/003; B29B 17/02; B29B 17/0412; B29B 2017/0289; B08B 13/00

(57) ABSTRACT

A method and apparatus for dosing treatment substances into a system for washing and recycling synthetic plastics is provided. The method includes providing a freely supported container operationally connected to a programmable weighing and control unit. The container is overturned by gravity between a treatment substance loading and unloading position. The method further includes storing a reference value of a weight suitable for overturning the container to the unloading position, supplying a treatment substance to the container, detecting the weight thereof, stopping the supply upon reaching a preset weight value, and supplying a washing substance to the container until the reference value is reached. Upon reaching the reference value, gravity overturns the container to the unloading position and sends the treatment substances to synthetics plastic washing modules.

### CROSS-REFERENCE TO RELATED APPLICATIONS

This application is a § 371 National Stage Entry of PCT/IB2016/001671 filed Nov. 25, 2016. Application No. PCT/IB2016/001671 claims priority of IT-UB2015A005870 filed Nov. 25, 2015. The entire content of these applications are incorporated herein by reference.

### BACKGROUND OF THE INVENTION

The invention relates to a method and apparatus for dosing one or more substances for treating plastics, in particular for dosing at least one liquid detergent in a system for washing and recycling plastics, such as PET for example.

### Prior Art

In the plastics recycling field, in particular the field of recycling post-consumer containers or bottles made of PET, it is known to subject the containers first to a pre-washing step with possible removal of the labels and subsequently to a grinding step in which the containers are reduced into flakes of small dimensions. These flakes are in turn washed further in suitable apparatuses forming part of an entire recycling system in order to remove from the flakes the contaminants and/or solid particles adhering thereto.

The flakes of plastics, which have to be subjected to a washing process, are supplied to special washing modules, where they are subjected to a hydraulic and mechanical action of a flow of water heated to a temperature, for example of 60-70° C. A chemical solution is then added to the water to enable the flakes of plastics to be both washed and moved. In order to ensure correct and efficient operation of the washing system, it is important to eliminate thoroughly the aforesaid contaminants and solid particles. As the continuous removal of the contaminating material entails progressive clouding of the water and rapid depletion of the chemical solution for washing, after a certain work time it is necessary to replace a great part of the depleted water with other water taken from the mains water supply that has to be suitably heated and supplemented with a new quantity of suitably dosed chemical solution for washing. In order to dose the chemical solution, it is known to use systems having sophisticated but equally delicate measuring apparatuses based on flowmeter sensors, flowrate meters, and volumetric pumping members, the use of which in the ambit of washing plastics to be recycled is accompanied by non-simple management and control of the dosing operations, and by very high costs.

In other sectors, for example the food and agricultural sector, dosing systems are known that provide containers for receiving the product to be dosed or measured, and suitable motors, devices-actuators and/or locking-releasing members that are driven to cause the aforesaid containers to move from a loading position to an unloading position of the aforesaid substance.

All the dosing systems disclosed above, in addition to being rather complex and costly, also prove to be equally delicate and require frequent maintenance, because of the heavy duty conditions in which they operate that are due to a work environment that is highly corrosive and characterised by a significant presence of dust or contaminating substances, as occurs in the field of treating and recycling plastics.

### Objects of the Invention

The general object of the present invention is to provide a method and an apparatus for dosing one or more substances for treating plastics, which method and apparatus are able to overcome the drawbacks of the systems that are commonly in use and are per se known.

In particular, one object of the present invention is to provide a different dosing method and apparatus, which enable, in an extremely simply but equally effective and reliable manner, detergents or chemical substances to be dosed in a system for washing and recycling plastics.

Another object of the invention is to provide a dosing apparatus that is simplified, both from the structural and the functional point of view, thus having great operational reliability and being financially very advantageous from the point of view of production, management and maintenance costs.

In other words, the invention proposes supplying an apparatus that is as simplified as possible, thus being of advantageous use in corrosive environments, and at the same time ensuring satisfactory operating efficacy and precision and an equally great versatility of use with the possibility of adjusting in the desired manner doses of the treatment substances intended for delivery into the plastics washing and recycling line.

### SHORT DESCRIPTION OF THE INVENTION

In particular, according to the present invention a method has been provided for dosing one or more treatment substances in a system for washing and recycling plastics, comprising the steps of:

a) providing a container supported in a freely oscillating manner and operationally connected to a programmable weighing and control unit, said container being overturnable by gravity between a loading position and an unloading position of said one or more treatment substances;

b) storing in said weighing and control unit a reference value of a weight which is suitable for overturning said container to said unloading position;

c) supplying a first treatment substance to said container detecting the weight thereof, and stopping the supply of said substance upon reaching a preset weight value; and

d) supplying a washing substance to said container until said reference value is reached, causing said container to overturn through the force of gravity in said unloading position for unloading and sending said treatment substance to plastics washing modules included in said system.

In a version of the method, after step c) and before step d), a step c′) is provided of further supplying a second treatment substance to the container and interrupting this further supplying when a further preset weight value is reached. The step d) follows of supplying the washing substance, which comprises in particular water taken from the mains water supply, to reach the aforesaid weight reference value and cause the container to overturn. The two treatment substances comprise, in particular, one liquid detergent and caustic soda, or anyway further treatment substances that are required for processing the plastics to be recycled.

According to another aspect of the invention, an apparatus is provided for dosing one or more treatment substances in a system for washing and recycling plastics, by the aforesaid method, comprising:

a container supported in a freely oscillating manner and overturnable by gravity from a loading position to an unloading position of said one or more treatment substances when a reference weight value is reached,

a programmable weighing and control unit, operationally connected to said container and comprising weight sensor means supporting said container,

a supply unit operationally connected to said programmable weighing and control unit and configured for selectively supplying to said container dosed quantities of one or more treatment substances and a washing substance;

said programmable weighing and control unit being configured for initially activating said supply unit for supplying and detecting the weight of a first quantity of treatment substance in said container, arresting the supply when a preset weight value is reached, and subsequently activating said supply unit for supplying to said container a quantity of washing substance until said reference value is reached to cause the overturning by gravity of said container to said unloading position.

In one embodiment, the apparatus further comprises a position sensor arrangement, such as one or more inductive proximity switches or other suitable switches, operationally connected to the programmable weighing and control unit and configured for monitoring the oscillating movement of the container following unloading of the contents thereof and providing a reference signal indicating the arrest of the container in the loading position to enable the receipt and loading of a further dose of the treatment substance/s.

Advantages and further features will be found in the following description and in the attached claims and drawings.

### SHORT DESCRIPTION OF THE DRAWINGS

FIG. 1 is a perspective view of the apparatus according to the invention, where for the sake of clarity some parts have been removed, such as the outer casing;

FIG. 2 is another view of the apparatus, in which the parts inside the casing have been made visible from the exterior;

FIG. 3 is a section view of the apparatus taken along the plane III-III in FIG. 2;

FIG. 4 is a section view of the apparatus taken along the plane IV-IV in FIG. 3;

FIG. 5 is a side view of the apparatus without some parts that have been removed for the sake of greater clarity, in which the container is in a loading position of the substances to be dosed;

FIG. 6 is a similar view to that of FIG. 5 but with the container in an unloading position of the dosed substances;

FIG. 7 shows a block diagram of the method and of the operation of the apparatus according to the invention.

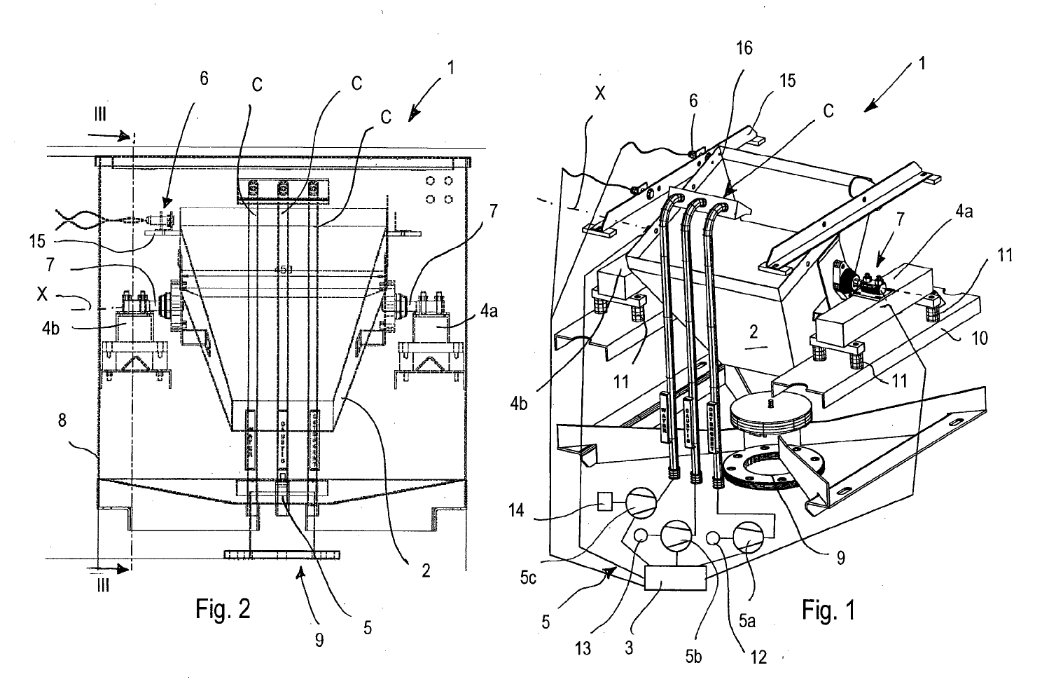

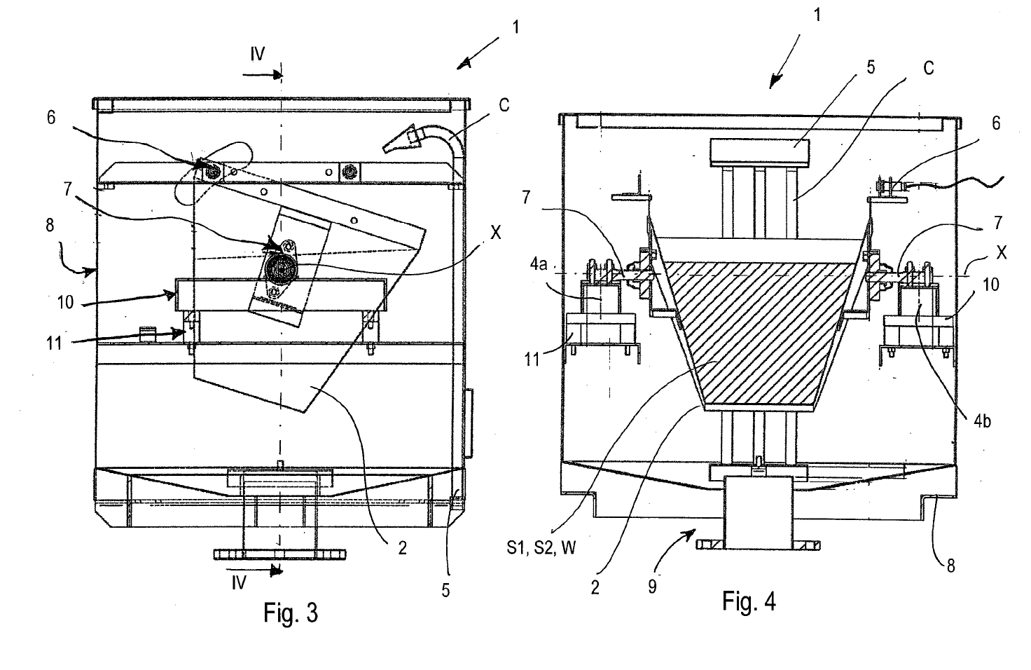

### DETAILED DESCRIPTION OF THE INVENTION

With reference to the attached figures, an apparatus 1 according to the invention is disclosed, which is suitable for dosing one or more treatment substances S1, S2, in a system for washing and recycling plastics, in particular and in a non-limiting manner, PET in flakes, obtained from bottles or other types of containers or products made of plastics arising from POST-consumption.

The apparatus 1 comprises a container 2 that is supported in a freely oscillating manner and is rotatable around a horizontal rotation axis X, and enclosed by a tank casing 8.

The tank casing 8 is provided below with an opening 9 for draining the content S1, S2, W from the container 2 to special plastics washing modules that are part of the entire recycling system.

The container 2 is mounted rotatably by suitable rotation pins 7, on a supporting structure 10 provided inside the tank casing 8.

The container 2 is configured and mounted in such a manner as to be overturnable by gravity from a loading position P1 of the treatment substance/s S1, S2, to an unloading position P2 of the latter once a weight reference value Y_{R} has been reached. In other words, the container 2 is so arranged that the horizontal rotation axis X is placed above and in an eccentric position in relation to the centre of, gravity B1 of the empty container 2. The container 2 is mounted in such a manner that when a determined weight reference value V_{R} is reached it overturns independently without the help of any driving member.

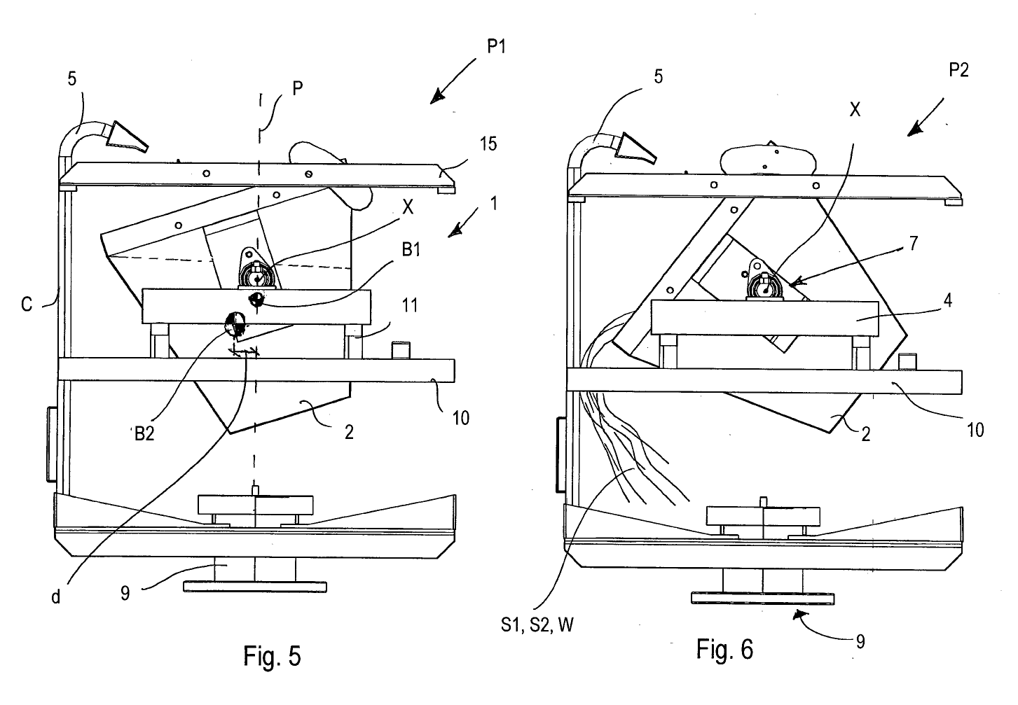

In other words, when the container 2 is filled with the required controlled doses of treatment substances and the remaining part of water, a new centre of gravity B2 is obtained (thus of the container 2 in a filled condition) which is spaced apart, by an amount “d” (shown in FIG. 5), from a vertical plane P passing through the rotation axis X; in this manner a mechanical moment is generated causing the overturning of the filled container 2 to the unloading position P2, as FIG. 6 shows.

The apparatus 1 comprises a programmable weighing and control unit 3, operationally connected to the container 2 and comprising a weight sensor device 4a, 4b.

The weight sensor device 4a, 4b supports the container 2.

In particular, the weight sensor device comprises a first weighing bar 4a and a second weighing bar 4b that support the container 2 on opposite sides.

The weighing bars 4a, 4b, each include a number of load cells or equivalent weight transducers.

The first weighing bar 4a and the second weighing bar 4b are mounted on suitable anti-vibration elements 11 fixed to the supporting structure 10.

The first weighing bar 4a and second weighing bar 4b extend parallel to one another and on opposite sides with respect to the container 2.

The apparatus 1 comprises a supply unit 5 operationally connected to the aforesaid programmable weighing and control unit 3 and configured for selectively supplying to the container 2 the desired dosed quantities of treatment substances S1, S2 and the washing substance W, such as water taken from the mains water supply.

The supply unit 5 comprises a first supplying unit 5a for a first substance S1, such as liquid detergent, a second supply unit 5b for a second substance S2, such as caustic soda, and a third supply unit 5c for a washing substance, in particular washing water W.

The first supplying unit 5a is connected to a first receptacle 12 or other suitable storage element containing the first substance S1.

The second supply unit 5b is connected to a second receptacle 13 or other suitable storage element containing the second substance S2.

The third supply unit 5c is connected to a connection 14 of the mains water supply.

The supply units 5a, 5b, 5c each include a respective dispensing conduit C that pours the substances S1, S2, W from above into the container 2.

The supply units 5a, 5b, 5c can comprise pump devices, and/or solenoid valve units, or other suitable systems for taking and delivering the requested substances.

The programmable weighing and control unit 3 is configured for initially activating the first supply unit 5a to supply and detect the weight of the first quantity of liquid detergent S1, or anyway in general the first treatment substance S1, accumulated in the container 2, and for stopping the supply thereof when a first preset weight value V1 is reached.

The first weight value V1 can be freely set in the programmable weighing and control unit 3 according to the process needs.

Similarly, the weighing and control unit 3 is programmable in such a manner that, after dosing the first substance S1, it activates the second supply unit 5b to dose by weighing the second substance S2, in this case caustic soda, or another desired substance, until a second requested weight value V2 is reached.

The weighing and control unit 3 is configured in such a manner as to—once the dosed quantities of the treatment substances S1 and S2 have been introduced into the container—activate the third supply unit 5c to supply water to reach the reference weight value V_{R} that is such as to cause the container 2 to overturn and the content thereof to be poured to the bottom of the tank casing 8 where, through the opening 9 for draining, it is conveyed to the washing modules of the recycling system of the plastics.

The supply sequence of the treatment substances S1, S2, in this case of caustic soda and liquid detergent, can be chosen freely. Further, by configuring the supply unit 5 suitably, it is possible to supply, in a controlled and ponderal manner, a different desired number of substances, for example more than two treatment substances or add other substances of a different nature if the need therefore should arise.

The apparatus 1 further comprises a position sensor arrangement 6 operationally connected to the programmable weighing and control unit 3.

The position sensor arrangement 6 is configured for monitoring the oscillating movement of the container 2 following unloading of the content S1, S2, W thereof, and providing a reference signal indicating the arrest of the container 2 in the loading position P1 for enabling receipt and loading of further doses of treatment substances S1, S2. In particular, the position sensor arrangement comprises an inductive proximity switch 6.

The inductive proximity switch 6 is mounted in a stationary position on a bracket 15 of the supporting structure of the apparatus 1.

The inductive proximity switch 6 is situated near a corner portion 16 of a wall of the container 2.

The inductive proximity switch 6 interacts without contact with the container 2, which is made of ferromagnetic material, or with an interaction element made of ferromagnetic material fixed to the container 2. The variation in the electromagnetic field due to the presence in the vicinity of the ferromagnetic material in oscillating movement (the corner of the container 2, or a Plate of metal fixed to the wall thereof) is translated into signals that suitably processed by the unit 3 provide an indication of the position of the container 2.

It is also possible to provide more than one inductive proximity switch 6.

The absence of mechanical actuating mechanisms and of physical contact between the proximity sensor and the container 2, and the peculiarity of the inductive proximity sensor 6 of not being influenced by dust or fragments of non-ferromagnetic materials in the vicinity further contributes to the reliability of use of the apparatus 1 in the ambit of plastics recycling.

In all cases, alternatively to the inductive proximity switch 6, one or more proximity sensors of another type, for example of optical type, can be used, or another equivalent type provided that they are suitable for operating without being influenced by the presence of dust or particles of materials that may become placed between the sensor and the container 2.

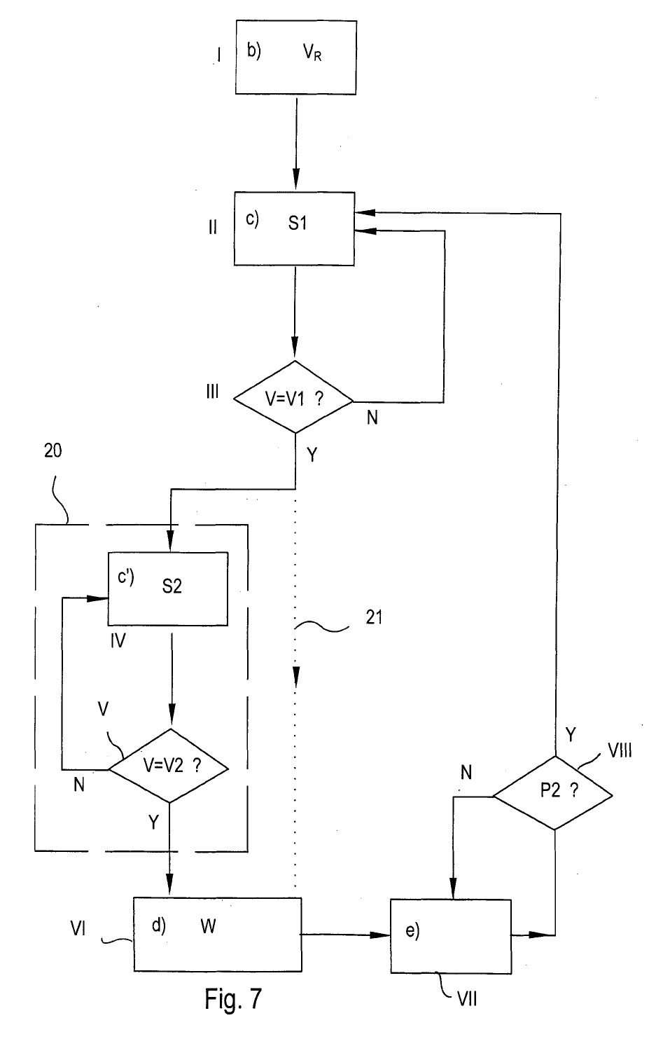

The operation of the apparatus 1 is disclosed below with the help of the block diagram of FIG. 7.

Once the weight reference value V_{R} has been stored in the weighing and control unit 3 (block “I” in FIG. 7, step b) of the method) that causes the autonomous overturning of the container 2 and which thus depends on the structural and geometric configuration of the container 2, the apparatus 1 is ready to operate. In the weighing and control unit 3 the first weight value V1 and the second weight value V2 are set that are associated respectively with the first treatment substance S1 (liquid detergent) and with the second treatment substance S2 (caustic soda) to be dosed in a weighted manner. At this point, the weighing and control unit 3 activates the supply unit 5, in particular the first supply unit 5a, which supplies to the container 2 the liquid detergent S1 (block “II”, step c)), When the weight V detected by the unit 3, owing to the signals of the weight sensors 4a, 4b, is equal to the first value V1, the supply of the liquid detergent S1 is interrupted. This step is represented by control block “III”, shown in FIG. 7.

At this point, (block “IV”, step c′)) the second supply unit 5b is activated to pour the caustic soda into the container 2. Similarly, when the new weight detected by the unit 3 corresponds to the reaching of the desired ponderal quantity of caustic soda (second weight value V2, indicated in the second control block “V”), the supply is interrupted and at this point the unit 3 activates the third supply unit 5c to introduce into the container 2 a quantity of water W (block “VI”, step d)) that is sufficient to cause the container 2 to overturn by gravity.

At the end of unloading, the container 2 oscillates to the loading position P1, whilst the proximity sensor 6 monitors the movement thereof (block “VII”, step e)). When the oscillating movement of the container 2 terminates, i.e. the stationary state is detected of the container 2 in the loading position P2 (control block “VIII”), the apparatus 1 is ready for starting a new losing cycle (new step c) represented by block “II”).

The apparatus 1 that has just been disclosed has great operational versatility. Owing to the programmable weighing and control unit 3, the apparatus 1 can operate in several modes. For example, it is possible to program the programmable weighing and control unit 3 so as to dose only one treatment substance; in this case the unit 3 will intervene to complete filling of the container 2 by supplying water to the container 2 until the aforementioned weight reference value V_{R} is reached. This possible operating mode, with reference to the diagram of FIG. 7, is symbolically represented by the connection of the control block “III”, by the flow line 21, directly to the block “VI”, (step d)) i.e. bypassing the module 20 (which comprises blocks “IV” and “V”).

According to another operating mode, two treatment substances S1, S2 are supplied in sequence, in weighted doses, the sum of which equals perfectly the reference value V_{R}, thus without the need to also add water. In other words, at the end of pouring of the dosed quantity of the substance S2 when the reference weight value V_{R} is reached, the container 2 overturns independently.

From what has been disclosed above, it is clear that the apparatus 1 has a reduced number of structural components, and is devoid of mechanical driving members for driving the container. Also the minimal presence of electric/electronic parts near the container 2, which is limited to the two weighing bars 4a, 4b, and to the proximity sensor 6, makes the apparatus 1 indicated for use in corrosive environments as occurs in the ambit of plastics recycling.

From what has been said and shown in the attached drawings, it is clear that a method and apparatus for the weight dosage have been provided that achieve the preset objects successfully.

In particular, owing to the invention an apparatus is provided that is extremely simplified structurally and functionally, which is useful in corrosive environments, simultaneously ensures satisfactory efficacy and operating precision and permits easy and versatile adjusting of the ponderal doses of the treatment substances intended for the delivery into the plastics washing and recycling line.

It is further understood that what has been said and shown in the attached drawings has been given merely by way of illustration of the apparatus and of the general features and of an embodiment of the apparatus according to the present invention. Thus any modifications or variants can be made to the entire apparatus, or to parts thereof and to the respective operating method, without this falling outside the scope of the claims.

1-13. (canceled)

14. Method for dosing one or more treatment substances in a system for washing and recycling plastics, comprising the steps of:
a. providing a container supported in a freely oscillating manner and operationally connected to a programmable weighing and control unit, said container being overturnable by gravity between a loading position and an unloading position of said one or more treatment substances;
b. storing in said weighing and control unit a reference value of a weight which is suitable to cause overturning of said container to said unloading position;
c. supplying a treatment substance to said container, detecting the weight thereof, and stopping the supply of said treatment substance upon reaching a preset weight value; and
d, supplying to said container a washing substance until said reference value is reached causing said container to overturn through the force of gravity in said unloading position for unloading and sending said treatment substance to plastics washing modules included in said system.

15. Method according to claim 14, wherein said container providing step further includes arranging said container so as to be supported rotatably around a horizontal rotation axis by said weighing and control unit, and positioning said rotation axis eccentrically above the centre of gravity of said empty container, in a position that is such that on reaching said reference weight value, the new centre of gravity of said filled container is spaced away from a vertical plane passing through said rotation axis, so as to generate a mechanical moment causing the overturning of said filled container to the unloading position.

16. Method according to claim 14, wherein said step of supplying said treatment substance is followed by a step of supplying a further treatment substance with detecting of the weight of the content that has progressively accumulated in said container, wherein supplying said further treatment substance is arrested on reaching a further preset weight value prior to said step of supplying washing substance until said reference value is reached to cause the overturning by gravity of said container to said unloading position.

17. Method according to claim 14, and further comprising the step of monitoring the oscillating movement of said container subsequent to the unloading of the contents thereof to identify the arrest thereof and the reaching again of said first loading position so as to start the receipt and loading of a further dose of said one or more treatment substances.

18. Method according to claim 14, wherein said treatment substance comprises a liquid detergent, said further treatment substance comprises caustic soda and said washing substance comprises water.

19. Method according to claim 16, wherein said steps of supplying treatment and further treatment substances comprise pumping liquid detergent and caustic soda respectively, said washing substance supplying step comprising pumping water into said container, and said plastics comprise PET material.

20. Apparatus for dosing one or more treatment substances in a system for washing and recycling plastics, by the method according to claim 14, comprising:
a container supported in a freely oscillating manner and overturnable by gravity from a loading position to an unloading position of said one or more treatment substances on reaching a reference weight value,
a programmable weighing and control unit, operationally connected to said container and comprising a weight sensor device supporting said container,
a supply unit operationally connected to said weighing and control unit and configured for selectively supplying to said container dosed quantities of one or more treatment substances and of a washing substance;
said programmable weighing and control unit being configured for initially activating said supply unit to supply and detect the weight of a first quantity of treatment substance in said container, stopping supplying upon reaching a preset weight value, and subsequently activating said supply unit to supply to said container a quantity of washing substance until said reference value is reached to cause the overturning by gravity of said container to said unloading position.

21. Apparatus according to claim 20, further comprising a position sensor arrangement operationally connected to said programmable weighing and control unit and configured for monitoring the oscillating movement of said container subsequent to the discharging of the content thereof and supplying a reference signal indicating the stop of said container in said loading position to enable the receipt and charging of a further dose of said one or more treatment substance.

22. Apparatus according to claim 21, wherein said position sensor arrangement comprises one or more inductive proximity switches.

23. Apparatus according to claim 21, wherein said position sensor arrangement comprises one or more optical positioning sensors.

24. Apparatus according to claim 20, wherein said weight sensor device comprises a first weighing bar and a second weighing bar on which rotation pins are pivotally mounted supporting, at opposite sides, said container.

25. Apparatus according to claim 20, wherein said supply unit comprises a first supplying unit, a second supplying unit and a third supplying unit that are suitable for sending to said container respectively, a liquid detergent, caustic soda, and washing water.

26. Apparatus according to any one of claim 20, wherein said container is housed inside a tank casing provided below with an opening for draining the content from the container to plastics washing modules of said system, in said tank casing there being provided a supporting structure having anti-vibration elements on which said weight sensor device supporting said container is mounted.
